(19) United States
(12) Patent Application Publication
(10) Pub. No.: US 2025/0026420 A1
(43) Pub. Date: Jan. 23, 2025

(54) TRACK FOR TRACTION OF A VEHICLE

(71) Applicant: Camso Inc., Magog (CA)

(72) Inventors: David Gingras, Magog (CA); Frederic Couture, Sherbrooke (CA)

(73) Assignee: Camso Inc., Magog (CA)

(21) Appl. No.: 18/907,793

(22) Filed: Oct. 7, 2024

Related U.S. Application Data
(62) Division of application No. 16/639,374, filed on Feb. 14, 2020, now Pat. No. 12,110,071.
(60) Provisional application No. 62/546,270, filed on Aug. 16, 2017.

(51) Int. Cl. B62D 55/24

(52) U.S. Cl. CPC B62D 55/244

(57) ABSTRACT

A track for traction of a vehicle is provided. The track comprises a ground-engaging outer side, an inner side opposite to the ground-engaging outer side, elastomeric material allowing the track to flex around wheels of the vehicle and a plurality of cores at least partially embedded in the elastomeric material. Each of the plurality of cores comprises a pair of wings extending in a longitudinal direction of the core, each wing of the pair comprising a delamination inhibitor configured to inhibit delamination of the elastomeric material from the wing, and a wheel engager disposed between the wings to engage the roller wheels. The delamination inhibitor provides a resistance to delamination of the elastomeric material of the track from cores at least partially embedded in the elastomeric material of the track.

### FIELD

This disclosure generally relates to tracks for traction of vehicles, such as construction vehicles and other off-road vehicles.

### BACKGROUND

Certain off-road vehicles, including industrial vehicles such as construction vehicles (e.g., loaders, excavators, bulldozers, pavers, telehandlers, etc.), agricultural vehicles (e.g., harvesters, combines, tractors, etc.), and forestry vehicles (e.g., feller-bunchers, tree chippers, knuckleboom loaders, etc.), for example, may be equipped with tracks which enhance their traction and floatation on soft, slippery and/or irregular grounds (e.g., soil, mud, sand, ice, snow, etc.) on which they operate.

A track of a track system of a vehicle may comprise elastomeric material (e.g., rubber) and cores embedded in its elastomeric material and spaced along and extending transversally to its longitudinal direction to impart transverse rigidity to the track and to drive and guide the track. As these cores may be metallic, the track may be a “metal-embedded rubber track” (MERT).

As the track is used, it is subject to various effects causing it to wear. For example, under loading of wheels of the track system and an environment of the vehicle, the elastomeric material of the track may crack. Grit (e.g., sand, rocks (e.g., gravel), and/or other small granular abrasive objects or other dirt, potentially contained in water and/or other liquid) may proceed to enter inside the track between its elastomeric material and its cores. This may cause the elastomeric material to delaminate from or otherwise lose adhesion to the cores, which may eventually render the track unusable.

For these and other reasons, there is a need to improve tracks for traction of vehicles.

### SUMMARY

According to various aspects, this disclosure relates to a track for traction of a vehicle (e.g., a compact track loader or other construction vehicle) which may be designed to enhance a resistance to wear of the track, including a resistance to cracking of elastomeric material of the track and a resistance to delamination of the elastomeric material of the track from cores at least partially embedded in the elastomeric material of the track.

For example, in accordance with an aspect, this disclosure relates to a track for traction of a vehicle. The track is mountable around a plurality of wheels that includes a plurality of roller wheels for rolling on a bottom run of the track along a rolling path of the track. The track comprises: a ground-engaging outer side; an inner side opposite to the ground-engaging outer side; elastomeric material allowing the track to flex around the wheels; a plurality of cores at least partially embedded in the elastomeric material, distributed in a longitudinal direction of the track, and extending transversally to the longitudinal direction of the track; and a cracking inhibitor disposed along the rolling path and configured to inhibit cracking of the elastomeric material at the rolling path.

In accordance with another aspect, this disclosure relates to a track for traction of a vehicle. The track is mountable around a plurality of wheels that includes a plurality of roller wheels for rolling on a bottom run of the track along a rolling path of the track. The track comprises: a ground-engaging outer side; an inner side opposite to the ground-engaging outer side; elastomeric material allowing the track to flex around the wheels; a plurality of cores; and a plurality of crack-inhibiting elements. The cores are at least partially embedded in the elastomeric material, distributed in a longitudinal direction of the track, and extend transversally to the longitudinal direction of the track. The crack-inhibiting elements are spaced apart from one another in the longitudinal direction of the track, disposed between respective ones of the cores in the longitudinal direction of the track, and configured to inhibit cracking of the elastomeric material at the rolling path.

In accordance with another aspect, this disclosure relates to a track for traction of a vehicle. The track is mountable around a plurality of wheels that includes a plurality of roller wheels for rolling on a bottom run of the track along a rolling path of the track. The track comprises: a ground-engaging outer side; an inner side opposite to the ground-engaging outer side; elastomeric material allowing the track to flex around the wheels; a plurality of cores; and a plurality of recesses. The cores are at least partially embedded in the elastomeric material, distributed in a longitudinal direction of the track, and extend transversally to the longitudinal direction of the track. The recesses are spaced apart from one another in the longitudinal direction of the track and disposed between respective ones of the cores in the longitudinal direction of the track along the rolling path.

In accordance with another aspect, this disclosure relates to a track for traction of a vehicle. The track is mountable around a plurality of wheels that includes a plurality of roller wheels for rolling on a bottom run of the track along a rolling path of the track. The track comprises: a ground-engaging outer side; an inner side opposite to the ground-engaging outer side; elastomeric material allowing the track to flex around the wheels; and a plurality of cores. The cores are at least partially embedded in the elastomeric material, distributed in a longitudinal direction of the track, and extend transversally to the longitudinal direction of the track. Each core comprises a pair of wings extending in a longitudinal direction of the core, and a wheel engager disposed between the wings to engage the wheels. Each wing comprises a delamination inhibitor configured to inhibit delamination of the elastomeric material from the wing.

In accordance with another aspect, this disclosure relates to a track for traction of a vehicle. The track is mountable around a plurality of wheels that includes a plurality of roller wheels for rolling on a bottom run of the track along a rolling path of the track. The track comprises: a ground-engaging outer side; an inner side opposite to the ground-engaging outer side; elastomeric material allowing the track to flex around the wheels; and a plurality of cores. The cores are at least partially embedded in the elastomeric material, distributed in a longitudinal direction of the track, and extend transversally to the longitudinal direction of the track. Each core comprises a pair of wings extending in a longitudinal direction of the core and a wheel engager disposed between the wings to engage the wheels. Each wing comprises a grit blocker configured to impede passage of grit between an inner surface of the wing and a portion of the elastomeric material contiguous to the inner surface of the wing.

In accordance with another aspect, this disclosure relates to a track for traction of a vehicle. The track is mountable around a plurality of wheels that includes a plurality of roller wheels for rolling on a bottom run of the track along a rolling path of the track. The track comprises: a ground-engaging outer side; an inner side opposite to the ground-engaging outer side; elastomeric material allowing the track to flex around the wheels; and a plurality of cores. The cores are at least partially embedded in the elastomeric material, distributed in a longitudinal direction of the track, and extend transversally to the longitudinal direction of the track. Each core comprises a pair of wings extending in a longitudinal direction of the core and a wheel engager disposed between the wings to engage the wheels. Each wing comprises an inner surface facing the inner side of the track. The inner surface of the wing comprises an unevenness in a longitudinal direction of the core.

In accordance with another aspect, this disclosure relates to a track for traction of a vehicle. The track is mountable around a plurality of wheels that includes a plurality of roller wheels for rolling on a bottom run of the track along a rolling path of the track. The track comprises: a ground-engaging outer side; an inner side opposite to the ground-engaging outer side; elastomeric material allowing the track to flex around the wheels; and a plurality of cores. The cores are at least partially embedded in the elastomeric material, distributed in a longitudinal direction of the track, and extend transversally to the longitudinal direction of the track. Each core comprises a pair of wings extending in a longitudinal direction of the core, and a wheel engager disposed between the wings to engage the wheels. Each wing comprises a shear limiter configured to oppose shearing of a portion of the elastomeric material contiguous to an inner surface of the wing relative to the inner surface of the wing under loading from respective ones of the roller wheels.

These and other aspects of this disclosure will now become apparent to those of ordinary skill in the art upon review of the following description of embodiments in conjunction with the accompanying drawings.

### BRIEF DESCRIPTION OF THE DRAWINGS

A detailed description of embodiments is provided below, by way of example only, with reference to the accompanying drawings, in which:

FIG. 1 shows an example of an embodiment of a vehicle comprising track systems;

FIG. 2 shows a perspective of a track system of the vehicle;

FIG. 3 shows a side view of the track system of the vehicle;

FIGS. 4 to 6 respectively show a perspective cross-sectional view, an inner view and a cross-sectional view of part of a track of the track system;

FIGS. 7 and 8 show cross-sectional views of a portion of the track system, including a frame and roller wheels of the track system;

FIGS. 9 to 11 show an example of another embodiment of the track;

FIGS. 12 to 14 show an example of another embodiment of the track;

FIG. 15 shows an example of another embodiment of the track;

FIGS. 16 and 17 show a perspective view and a top plan view of a core of the track; and

FIGS. 18 and 19 show cross-sectional views of the track, including the core.

It is to be expressly understood that the description and drawings are only for the purpose of illustrating certain embodiments and are an aid for understanding. They are not intended to be limitative.

### DETAILED DESCRIPTION OF EMBODIMENTS

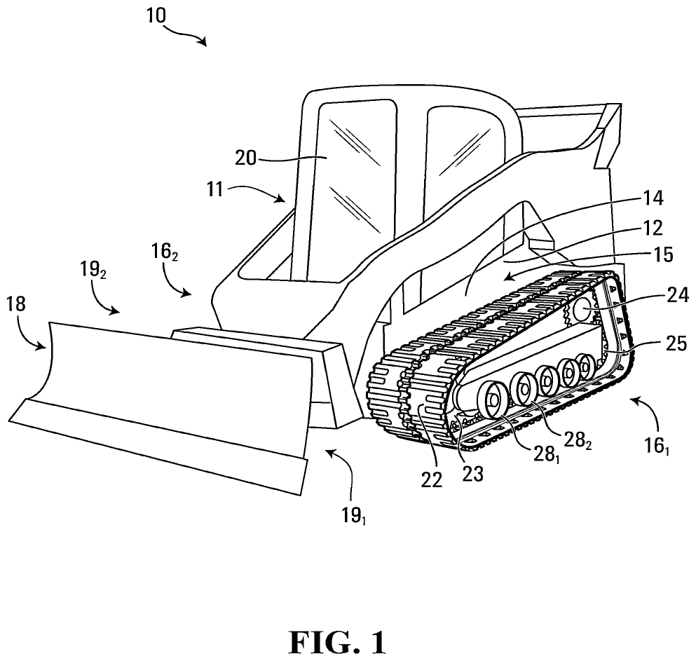

FIG. 1 shows an example of an embodiment of a vehicle 10 comprising track systems 16₁, 16₂. Each of the track systems 16₁, 16₂ comprises a track 22 to engage the ground. In this embodiment, the vehicle 10 is a heavy-duty work vehicle for performing construction, agricultural, or other industrial work or military work. More particularly, in this embodiment, the vehicle 10 is a construction vehicle. Specifically, in this example, the construction vehicle 10 is a compact track loader. The vehicle 10 comprises a frame 12, a powertrain 15, and an operator cabin 20 for an operator to move the vehicle 10 on the ground to perform work using a work implement 18.

As further discussed below, in this embodiment, the track 22 of each of the track systems 16₁, 16₂ may be designed to enhance a resistance to wear of the track 22, including a resistance to cracking of elastomeric material of the track 22 and a resistance to delamination of the elastomeric material of the track 22 from cores at least partially embedded in the elastomeric material of the track 22.

The powertrain 15 is configured to generate motive power for the track systems 16₁, 16₂ to propel the vehicle 10 on the ground. To that end, the powertrain 15 comprises a prime mover 14 which is a source of motive power that comprises one or more motors.

For example, in this embodiment, the prime mover 14 comprises an internal combustion engine. In other embodiments, the prime mover 14 may comprise another type of motor (e.g., an electric motor) or a combination of different types of motor (e.g., an internal combustion engine and an electric motor). Motive power generated by the prime mover 14 is applied to the track systems 16₁, 16₂. In some embodiments, the powertrain 15 may transmit power from the prime mover 14 to the track systems 16₁, 16₂ (e.g., via a transmission, a differential, and/or any other suitable mechanism). In other embodiments, at least part of the powertrain 15 (e.g., a motor and/or a transmission) may be part of one or more of the track systems 16₁, 16₂.

The operator cabin 20 comprises a user interface 11 that allow the operator to interact with the vehicle 10, including to steer the vehicle 10 on the ground, use the work implement 18, and control other aspects of the vehicle 10. For example, the user interface 11 comprises an accelerator, a brake control, and a steering device that can be used by the operator to control motion of the vehicle 10 on the ground, as well as controls to operate the work implement 18. The user interface 11 may also comprise an instrument panel (e.g., a dashboard) which provides indicators (e.g., a speedometer indicator, a tachometer indicator, etc.) to convey information to the operator.

The work implement 18 is operable to perform work. In this embodiment, the work implement 18 comprises a bucket for moving soil, debris or other material. In this example, the vehicle 10 comprises support arms 19₁, 19₂ carrying the work implement 18 and mounted to a rear part 21 of the frame 12 so that they extend forwardly pass the operator cabin 20. In other embodiments, the work implement 18 may comprise a dozer blade, a backhoe, a fork, a grapple, a scraper pan, an auger, a saw, a ripper, a material-handling arm, or any other type of work implement.

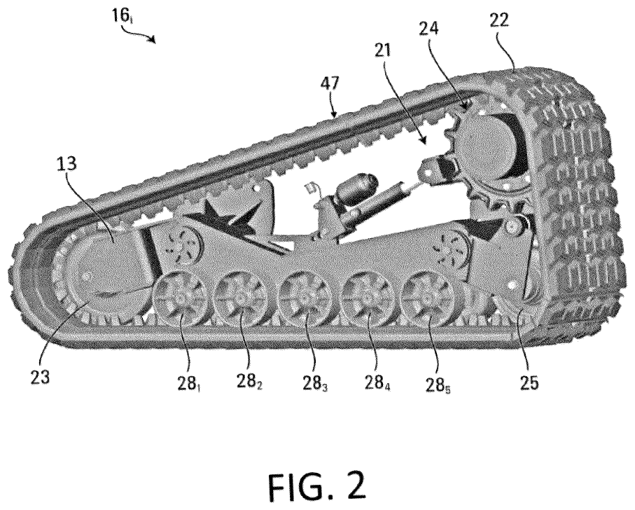

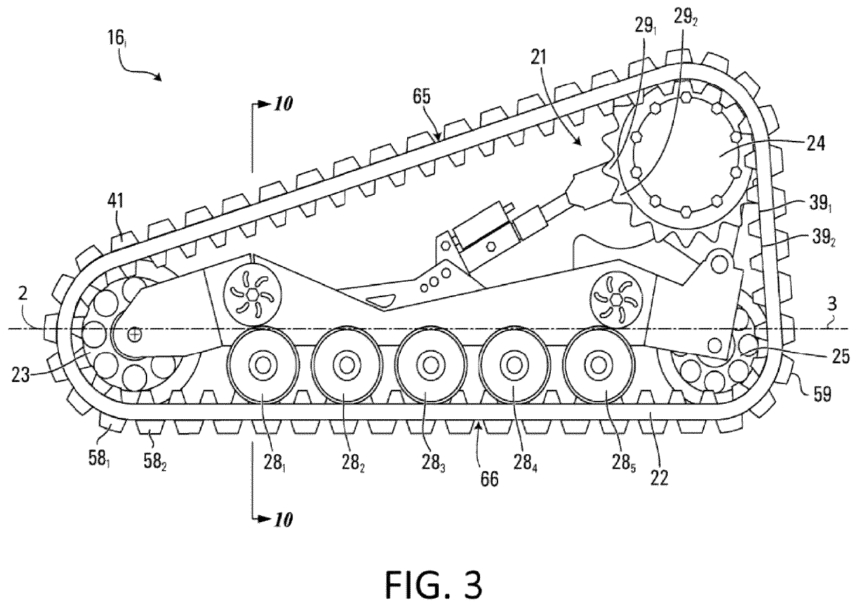

The track systems 16₁, 16₂ engage the ground to propel the vehicle 10. With additional reference to FIGS. 2 to 3, each track system 16ᵢ comprises a track-engaging assembly 21 and the track 22 disposed around the track-engaging assembly 21. In this embodiment, the track-engaging assembly 21 comprises a plurality of wheels which, in this example, includes a drive wheel 24 and a plurality of idler wheels that includes a front (i.e., leading) idler wheel 23, a rear (i.e., trailing) idler wheel 25, and roller wheels 28₁-28₁₀. The track system 16ᵢ also comprises a frame 13 which supports various components of the track system 16;, including the wheels 24, 23, 25, 28₁-28₁₀. In this embodiment, the vehicle 10 can be steered by operating the track systems 16₁, 16₂ differently, such as by moving their tracks 22 at different speeds and/or in different directions.

The track system 16ᵢ has a longitudinal direction and a front longitudinal end 57 and a rear longitudinal end 59 that define a length of the track system 16ᵢ along a longitudinal axis 61 that defines the longitudinal direction of the track system 16ᵢ. The track system 16ᵢ has a widthwise direction and a width that is defined by a width W_{T} of the track 22. The track system 16ᵢ also has a heightwise direction that is normal to its longitudinal and widthwise directions.

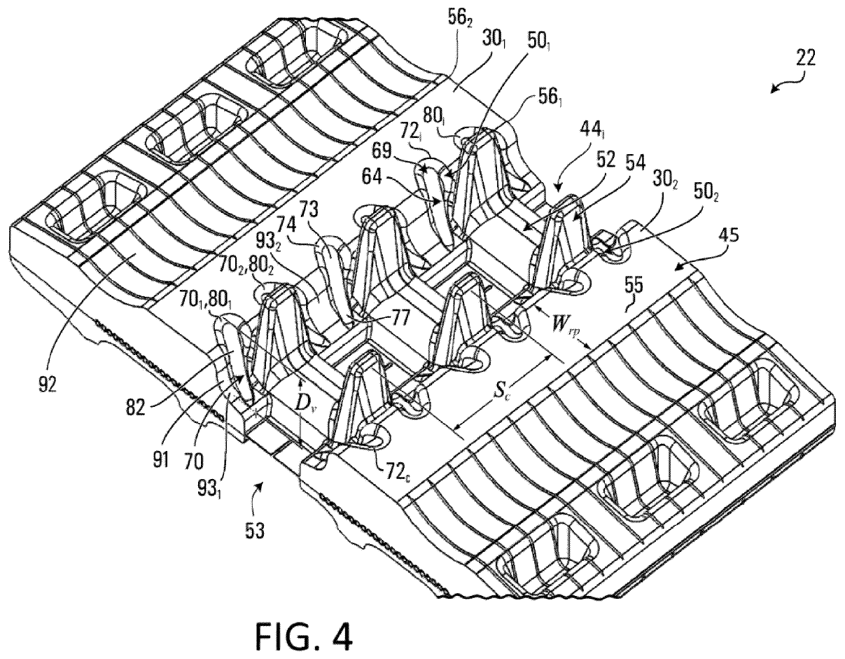

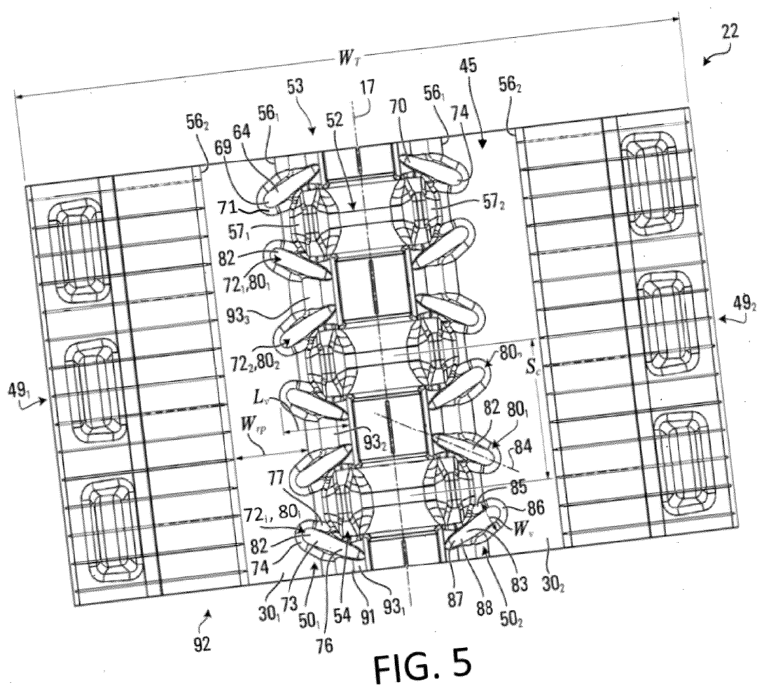

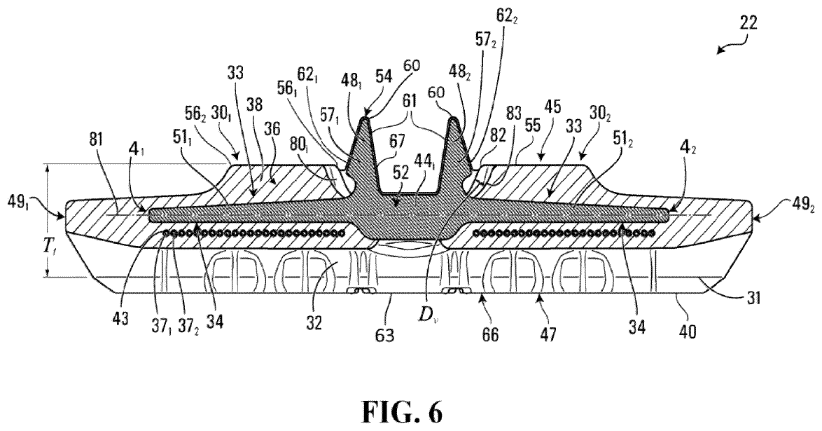

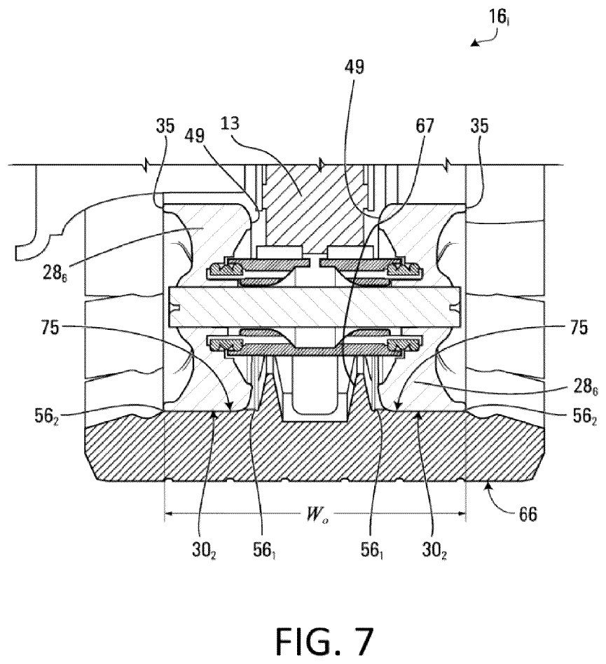

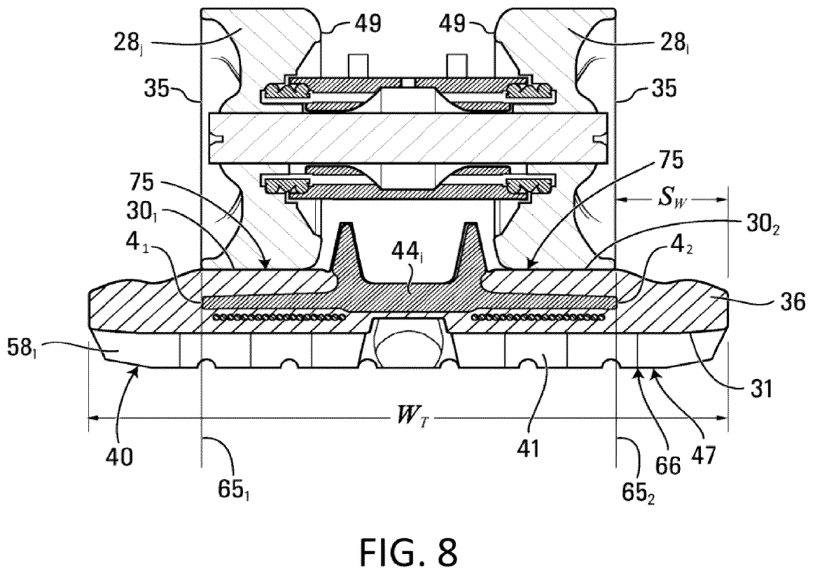

The track 22 engages the ground to provide traction to the vehicle 10. A length of the track 22 allows the track 22 to be mounted around the track-engaging assembly 21. In view of its closed configuration without ends that allows it to be disposed and moved around the track-engaging assembly 21, the track 22 can be referred to as an “endless” track. With additional reference to FIGS. 4 to 6, the track 22 comprises an inner side 45, a ground-engaging outer side 47, and lateral edges 49₁, 49₂. The inner side 45 faces the wheels 24, 23, 25, 28₁-28₁₀, while the ground-engaging outer side 47 engages the ground. A top run 65 of the track 22 extends between the longitudinal ends 57, 59 of the track system 16ᵢ and over the wheels 24, 23, 25, 28₁-28₁₀, whereas a bottom run 66 of the track 22 extends between the longitudinal ends 57, 59 of the track system 16ᵢ and under the wheels 24, 23, 25, 28₁-28₁₀. The bottom run 66 of the track 22 defines an area of contact 63 of the track 22 with the ground which generates traction and bears a majority of a load on the track system 16ᵢ, and which will be referred to as a “contact patch” of the track 22 with the ground. The track 22 has a longitudinal axis 19 which defines a longitudinal direction of the track 22 (i.e., a direction generally parallel to its longitudinal axis) and transversal directions of the track 22 (i.e., directions transverse to its longitudinal axis), including a widthwise direction of the track 22 (i.e., a lateral direction generally perpendicular to its longitudinal axis). The track 22 has a thicknesswise direction normal to its longitudinal and widthwise directions.

The track 22 is elastomeric, i.e., comprises elastomeric material 32, to be flexible around the track-engaging assembly 21. The elastomeric material 32 of the track 22 can include any polymeric material with suitable elasticity. In this embodiment, the elastomeric material of the track 22 includes rubber. Various rubber compounds may be used and, in some cases, different rubber compounds may be present in different areas of the track 22. In other embodiments, the elastomeric material 32 of the track 22 may include another elastomer in addition to or instead of rubber (e.g., polyurethane elastomer).

More particularly, the track 22 comprises an endless body 36 underlying its inner side 45 and ground-engaging outer side 47. In view of its underlying nature, the body 36 will be referred to as a “carcass”. The carcass 36 is elastomeric in that it comprises elastomeric material 38 which allows the carcass 36 to elastically change in shape and thus the track 22 to flex as it is in motion around the track-engaging assembly 21.

In this embodiment, a plurality of cores 44₁-44_{N} are at least partially embedded in the elastomeric material 38 of the carcass 36. The cores 44₁-44_{N} are distributed along and extend transversally to the longitudinal direction of the track 22 to impart transverse rigidity to the track 22. The cores 44₁-44_{N} may also help to drive the track 22 by engagement with the drive wheel 24 and/or guide the track 22 by contacting the wheels 23, 25, 28₁-28₁₀ as the track 22 is driven by the drive wheel 24.

Each core 44ᵢ has a longitudinal axis 81 extending transversally to the longitudinal axis 45 of the track 22 and defining a longitudinal direction of the core 44ᵢ. In this example, the longitudinal axis 81 of the core 44ᵢ extends perpendicularly to the longitudinal axis 45 of the track 22, such that it is oriented in the widthwise direction of the track 22. In this embodiment, the core 44ᵢ has a length which is shorter than the width of the track 22 such that it has longitudinal ends 48₁, 48₂ that are spaced apart from the lateral edges 49₁, 49₂ of the track 22. The core 44ᵢ also has a widthwise direction and a thicknesswise direction that are normal to its longitudinal direction.

More particularly, in this embodiment, the core 44ᵢ comprises a pair of wings 51₁, 51₂ (i.e., extensions) and a wheel engager 53 disposed between the wings 51₁, 51₂.

The wings 51₁, 51₂ are elongated along the longitudinal axis 81 of the core 44ᵢ to impart transverse rigidity to the track 22. Each of the wings 51₁, 51₂ has an inner surface 33 oriented towards the inner side 45 of the track 22 and an outer surface 34 oriented towards the ground-engaging outer side 47 of the track 22. In this embodiment, each of the wings 51₁, 51₂ has a tapered shape whereby its inner surface 33 and its outer surface 34 converge towards one another toward a given one of the longitudinal ends 48₁, 48₂ of the core 44ᵢ. The wings 51₁, 51₂ may have any other shape in other embodiments.

The wheel engager 53 is configured to engage respective ones of the wheels 23, 25, 28₁-28₁₀ as the track 22 is driven by the drive wheel 24. More particularly, in this embodiment, the wheel engager 53 comprises a drive portion 52 for engaging the drive wheel 24 to drive the track 22 and a wheel guide 54 that projects on the inner side 55 of the track 22 for contacting the roller wheels 28₁-28₁₀ to help guide the track 22. In this example, the wheel guide 54 comprises a pair of guide projections 57₁, 57₂ that project on the inner side 55 of the track 22. Each guide projection 57ᵢ comprises a top end 60, a base 61, and a pair of wheel-facing sides 62₁, 62₂ opposite one another and extending from its base 61 to its top end 60. The wheel engager 53 may be configured in various other ways in other embodiments (e.g., it may comprise only one guide projection or more than two (2) guide projections, etc.).

The core 44ᵢ may be made in any suitable way. In this embodiment, the core 44ᵢ including its wings 51₁, 51₂ and its wheel engager 53, is made of metallic material. More particularly, in this embodiment, the core 44ᵢ may be made of steel formed into shape by casting. The core 44ᵢ may have various other shapes, may comprise various other components, may be made of various other materials (e.g., polymers, ceramics, composites, etc.), and/or may be made using various other processes (e.g., forging, welding, fastening, etc.) in other embodiments.

In this embodiment, the carcass 36 comprises a layer of reinforcing cables 37₁-37_{M} that are adjacent to one another and extend generally in the longitudinal direction of the track 22 to enhance strength in tension of the track 22 along its longitudinal direction. In this case, each of the reinforcing cables 37₁-37_{M} is a cord including a plurality of strands (e.g., textile fibers or metallic wires). In other cases, each of the reinforcing cables 37₁-37_{M} may be another type of cable and may be made of any material suitably flexible along the cable's longitudinal axis (e.g., fibers or wires of metal, plastic or composite material).

Also, in this embodiment, the carcass 36 comprises a layer of reinforcing fabric 43. The reinforcing fabric 43 comprises thin pliable material made usually by weaving, felting, knitting, interlacing, or otherwise crossing natural or synthetic elongated fabric elements, such as fibers, filaments, strands and/or others, such that some elongated fabric elements extend transversally to the longitudinal direction of the track 22 to have a reinforcing effect in a transversal direction of the track 22. For instance, the reinforcing fabric 43 may comprise a ply of reinforcing woven fibers (e.g., nylon fibers or other synthetic fibers).

The carcass 36 may be molded into shape in a molding process during which the rubber 38 is cured. For example, in this embodiment, a mold may be used to consolidate layers of rubber providing the rubber 38 of the carcass 36, the cores 44₁-44_{N}, the reinforcing cables 37₁-37_{M}, and the layer of reinforcing fabric 43.

The inner side 45 of the track 22 comprises an inner surface 55 of the carcass 36 and a plurality of wheel-contacting projections 48₁-48_{N} that project from the inner surface 55 and are positioned to contact respective ones of the wheels 23, 25, 28₁-28₁₀ to do at least one of guiding the track 22 and driving (i.e., imparting motion to) the track 22. Since each of them is used to do at least one of guiding the track 22 and driving the track 22, the wheel-contacting projections 48₁-48_{N} can be referred to as “guide/drive projections”. In this embodiment, each guide/drive projection 48ᵢ interacts with respective ones of the idler wheels 23, 25, 28₁-28₁₀ to guide the track 22 to maintain proper track alignment and prevent de-tracking without being used to drive the track 22, in which case the guide/drive projection 48ᵢ is a guide projection. In other embodiments, a guide/drive projection 48ᵢ may interact with the drive wheel 24 to drive the track 22, in which case the guide/drive projection 48ᵢ is a drive projection. In yet other embodiments, a guide/drive projection 48ᵢ may both (i) interact with the drive wheel 24 to drive the track and (ii) interact with respective ones of the idler wheels 23, 25, 28₁-28₁₀ to guide the track 22 to maintain proper track alignment and prevent de-tracking, in which case the guide/drive projection 48ᵢ is both a drive projection and a guide projection.

In this embodiment, each guide projection 48ᵢ comprises elastomeric material 67 overlying a given one of the guide projections 57₁, 57₂ of the cores 44₁-44_{N}. The elastomeric material 67 can be any polymeric material with suitable elasticity. More particularly, in this embodiment, the elastomeric material 67 includes rubber. Various rubber compounds may be used and, in some cases, different rubber compounds may be present in different areas of the drive/guide projection 48ᵢ. The elastomeric material 67 of the guide projection 48ᵢ may be provided on the inner side 45 of the track 22 in various ways. For example, in this embodiment, the elastomeric material 67 of the guide projection 48ᵢ is provided by being molded with the carcass 36.

The inner side 45 of the track 22 comprises rolling paths 30₁, 30₂ on which the roller wheels 28₁-28₁₀ roll to apply the bottom run 66 of the track 22 onto the ground. For example, a peripheral surface 75 of each roller wheel 28ᵢ between an outer lateral surface 35 and an inner lateral surface 49 of the roller wheel 28ᵢ is in rolling contact with a given one of the rolling paths 30₁, 30₂ of the track 22. Each of the rolling paths 30₁, 30₂ of the track 22 comprises an inner lateral edge 56₁ and an outer lateral edge 56₂ that define a width Wᵣₚ of that rolling path.

The ground-engaging outer side 47 of the track 22 comprises a ground-engaging outer surface 31 of the carcass 36 and a tread pattern 40 to enhance traction on the ground. The tread pattern 40 comprises a plurality of traction projections 58₁-58_{T} projecting from the ground-engaging outer surface 31, spaced apart in the longitudinal direction of the track 22 and engaging the ground to enhance traction. The traction projections 58₁-58_{T} may be referred to as “tread projections” or “traction lugs”. The traction lugs 58₁-58_{T} may have any suitable shape (e.g., curved shapes, shapes with straight parts and curved parts, etc.).

In this embodiment, each traction lug 58ᵢ is an elastomeric traction lug in that it comprises elastomeric material 41. The elastomeric material 41 can be any polymeric material with suitable elasticity. More particularly, in this embodiment, the elastomeric material 41 includes rubber. Various rubber compounds may be used and, in some cases, different rubber compounds may be present in different areas of the traction lug 58ᵢ. In other embodiments, the elastomeric material 41 may include another elastomer in addition to or instead of rubber (e.g., polyurethane elastomer).

The traction lugs 58₁-58_{T} may be provided on the ground-engaging outer side 47 of the track 22 in various ways. For example, in this embodiment, the traction lugs 58₁-58_{T} are provided on the ground-engaging outer side 47 of the track 22 by being molded with the carcass 36.

The drive wheel 24 is rotatable by power derived from the powertrain 15 to drive the track 22. In this embodiment, the drive wheel 24 is a drive sprocket comprising a plurality of drive members 29₁, 29_{D} spaced apart circumferentially to engage the drive portion 52 of each of the cores 44₁-44_{N} in order to drive the track 22 (e.g., a “positive drive” arrangement). In this example, the track 22 comprises drive voids 39₁, 39_{V} (e.g., recesses or holes) to receive the drive members 29₁, 29_{D} of the drive wheel 24.

The idler wheels 23, 25, 28₁-28₁₀ are not driven by power supplied by the powertrain 15, but are rather used to do at least one of supporting part of a weight of the vehicle 10 on the ground via the track 22, guiding the track 22 as it is driven by the drive wheel 24, and tensioning the track 22. More particularly, in this embodiment, the front and rear idler wheel 23, 25 maintain the track 22 in tension and help to support part of the weight of the vehicle 10 on the ground via the track 22. The roller wheels 28₁-28₁₀ roll on the rolling paths 30₁, 30₂ of the track 22 along the bottom run 66 of the track 22 to apply it onto the ground.

The track 22 may be designed to enhance its resistance to wear, including its resistance to cracking and its resistance to delamination of its elastomeric material 32 from its cores 44₁-44_{N}. Examples of features that the track 22 may have in this regard in some embodiments are discussed below.

### 1. Cracking Inhibition

In some embodiments, as shown in FIGS. 4 to 6, the track 22 may comprise cracking inhibitors 50₁, 50₂ configured to inhibit cracking of the elastomeric material 32 of the track 22 at the rolling paths 30₁, 30₂ of the track 22. Each of the cracking inhibitors 50₁, 50₂ is a structure disposed along a given one of the rolling paths 30₁, 30₂ and designed to at least reduce (i.e., reduce or prevent) cracking of the elastomeric material 32 of the track 22 at the given one of the rolling paths 30₁, 30₂ of the track 22 by at least reducing (i.e., reducing or preventing) crack initiation and/or crack propagation where that cracking inhibitor is located.

The cracking inhibitor 50₁ for the rolling path 30₁ of the track 22 will be further discussed below, with an understanding that a similar discussion applies to the cracking inhibitor 50₂ for the rolling path 30₂ of the track 22.

As further discussed below, in this embodiment, the cracking inhibitor 50₁ is configured to reduce tension and compression of the elastomeric material 32 of the track 22 at the rolling path 30₁ of the track 22 as the roller wheels 28₁-28₁₀ move away and towards respective ones of the cores 44₁-44_{N}. This may help to reduce or prevent cracking of the elastomeric material 32 of the track 22, such as cracking that may otherwise tend to occur rapidly near the wheel guide 54 of each of the cores 44₁-44_{N} and propagate laterally outwards.

In this embodiment, at least part of the cracking inhibitor 50₁ is located between the drive portion 52 of each of the cores 44₁-44_{N} and the outer lateral edge 56₂ of the rolling path 30₁ in the widthwise direction of the track 22. More particularly, in this embodiment, at least part of the cracking inhibitor 50₁ is located between the wheel guide 54 of each of the cores 44₁-44_{N} and the outer lateral edge 562 of the rolling path 30₁ in the widthwise direction of the track 22. In this example, at least part of the cracking inhibitor 50ᵢ is located between the guide projection 57₁ of each of the cores 44₁-44_{N} that is adjacent to the rolling path 30₁ and the outer lateral edge 56₂ of the rolling path 30₁ in the widthwise direction of the track 22. In this case, at least part of the cracking inhibitor 50ᵢ is located in the rolling path 30₁, i.e., between the inner lateral edge 56₁ and the outer lateral edge 56₂ of the rolling path 30₁ in the widthwise direction of the track 22.

Thus, in this embodiment, a portion 64 of the cracking inhibitor 50ᵢ is located between the wheel guide 54 of each of the cores 44₁-44_{N} and the outer lateral edge 56₂ of the rolling path 30₁ in the widthwise direction of the track 22. Here, the portion 64 of the cracking inhibitor 50₁ is located between the guide projection 57₁ of each of the cores 44₁-44_{N} and the outer lateral edge 56₂ of the rolling path 30₁ in the widthwise direction of the track 22. This includes a portion 69 of the cracking inhibitor 50₁ that is located in the rolling path 30₁, i.e., between the inner lateral edge 56₁ and the outer lateral edge 56₂ of the rolling path 30₁ in the widthwise direction of the track 22.

More particularly, in this embodiment, the cracking inhibitor 50₁ is adjacent to the inner lateral edge 56₁ of the rolling path 3₀₁, i.e., closer to the inner lateral edge 56₁ of the rolling path 30₁ than to the outer lateral edge 56₂ of the rolling path 30₁ in the widthwise direction of the track 22. Also, in this embodiment, the cracking inhibitor 50₁ overlaps with the wheel guide 54 of each of the cores 44₁-44_{N} in the widthwise direction of the track 22. Here, the cracking inhibitor 50₁ overlaps with the guide projection 571 of each of the cores 44₁-44_{N} in the widthwise direction of the track 22. A portion 70 of the cracking inhibitor 50ᵢ is thus aligned with the wheel guide 54 of each of the cores 44₁-44_{N}, in this case the guide projection 57₁ of each of the cores 44₁-44_{N}, in the widthwise direction of the track 22. Furthermore, in this embodiment, the cracking inhibitor 50₁ overlaps with each of the cores 44₁-44_{N} in the longitudinal direction of the track 22. A portion 71 of the cracking inhibitor 50ᵢ is thus aligned with each of the cores 44₁-44_{N} in the longitudinal direction of the track 22.

The cracking inhibitor 50₁ may be implemented in any suitable way. In this embodiment, the cracking inhibitor 50₁ comprises a plurality of crack-inhibiting elements 72₁-72_{C} distributed along the rolling path 30₁ of the track 22. More particularly, in this embodiment, the crack-inhibiting elements 72₁-72_{C} are spaced apart from one another in the longitudinal direction of the track 22. Also, plural ones (in this case, two) of the crack-inhibiting elements 72₁-72_{C} are disposed along the rolling path 30₁ between successive ones of the cores 44₁-44_{N} that succeed one another in the longitudinal direction of the track 22.

Each crack-inhibiting element 72ᵢ is configured to at least reduce cracking of the elastomeric material 32 of the track 22 at the rolling path 30₁ by at least reducing crack initiation and/or crack propagation where the crack-inhibiting element 72ᵢ is located.

In this embodiment, at least part of the crack-inhibiting element 72ᵢ is located between the drive portion 52 of an adjacent one of the cores 44₁-44_{N} and the outer lateral edge 56₂ of the rolling path 30₁ in the widthwise direction of the track 22. More particularly, in this embodiment, at least part of the crack-inhibiting element 72ᵢ is located between the wheel guide 54 of the adjacent one of the cores 44₁-44_{N} and the outer lateral edge 56₂ of the rolling path 30₁ in the widthwise direction of the track 22. In this example, at least part of the crack-inhibiting element 72ᵢ is located between the guide projection 57₁ of the adjacent one of the cores 44₁-44_{N} and the outer lateral edge 56₂ of the rolling path 30₁ in the widthwise direction of the track 22. In this case, at least part of the crack-inhibiting element 72ᵢ is located in the rolling path 30₁, i.e., between the inner lateral edge 56₁ and the outer lateral edge 56₂ of the rolling path 30₁ in the widthwise direction of the track 22.

Thus, in this embodiment, a portion 73 of the crack-inhibiting element 72ᵢ is located between the wheel guide 54 of the adjacent one of the cores 44₁-44_{N} and the outer lateral edge 56₂ of the rolling path 30₁ in the widthwise direction of the track 22. Here, the portion 73 of the crack-inhibiting element 72ᵢ is located between the guide projection 571 of the adjacent one of the cores 44₁-44_{N} and the outer lateral edge 56₂ of the rolling path 30₁ in the widthwise direction of the track 22. This includes a portion 74 of the crack-inhibiting element 72ᵢ that is located in the rolling path 30₁, i.e., between the inner lateral edge 56₁ and the outer lateral edge 56₂ of the rolling path 30₁ in the widthwise direction of the track 22. As such, in this example, the portions 73 of the crack-inhibiting elements 72₁-72_{C} collectively constitute the portion 64 of the cracking inhibitor 50ᵢ that is located between the wheel guide 54 of each of the cores 44₁-44_{N} and the outer lateral edge 56₂ of the rolling path 30₁ in the widthwise direction of the track 22, and the portions 74 of the crack-inhibiting elements 72₁-72_{C} collectively constitute the portion 69 of the cracking inhibitor 50₁ that is located in the rolling path 30₁.

More particularly, in this embodiment, the crack-inhibiting element 72ᵢ is adjacent to the inner lateral edge 56₁ of the rolling path 30₁, i.e., closer to the inner lateral edge 56₁ of the rolling path 30₁ than to the outer lateral edge 56₂ of the rolling path 30₁ in the widthwise direction of the track 22. Also, in this embodiment, the crack-inhibiting element 72ᵢ overlaps with the wheel guide 54 of the adjacent one of the cores 44₁-44_{N} in the widthwise direction of the track 22. Here, the crack-inhibiting element 72ᵢ overlaps with the guide projection 57₁ of the adjacent of the cores 44₁-44_{N} in the widthwise direction of the track 22. A portion 76 of the crack-inhibiting element 72ᵢ is thus aligned with the wheel guide 54 of the adjacent one of the cores 44₁-44_{N} , in this case the guide projection 57₁ of the adjacent one of the cores 44₁-44_{N}, in the widthwise direction of the track 22. Furthermore, in this embodiment, the crack-inhibiting element 72ᵢ overlaps with the adjacent one of the cores 44₁-44_{N} in the longitudinal direction of the track 22. A portion 77 of the crack-inhibiting element 72ᵢ is thus aligned with the adjacent one of the cores 44₁-44_{N} in the longitudinal direction of the track 22. Accordingly, in this example, the portions 76 of the crack-inhibiting elements 72₁-72_{C} collectively constitute the portion 70 of the cracking inhibitor 50ᵢ that is aligned with the wheel guide 54 of each of the cores 44₁-44_{N} in the widthwise direction of the track 22, and the portions 77 of the crack-inhibiting elements 72₁-72_{C} collectively constitute the portion 71 of the cracking inhibitor 50ᵢ that is aligned with each of the cores 44₁-44_{N} in the longitudinal direction of the track 22.

In this embodiment, the rolling path 30₁ is elevated relative to an inner lower area 91 and an outer lower area 92 of the inner side 45 of the track 22 between which it is disposed in the widthwise direction of the track 22, such that the crack-inhibiting element 72ᵢ is located in the inner lower area 91 of the inner side 45 of the track 22. More particularly, in this embodiment, the inner lower area 91 of the inner side 25 of the track 22 comprises depressions 93₁-93_{D} between respective ones of the cores 44₁-44_{N} and at least part of the crack-inhibiting element 72ᵢ is located in a given one of the depressions 93₁-93_{D}.

The crack-inhibiting elements 72₁-72_{C} may be implemented in any suitable way. In this embodiment, the crack-inhibiting elements 72₁-72_{C} are stress relievers 80₁-80_{C}, i.e., each crack-inhibiting element 72ᵢ is a respective one of the stress relievers 80₁-80_{C}.

Each of the stress relievers 80₁-80_{C} is configured to relieve stress in the elastomeric material 32 of the track 22 at the rolling path 30₁ where that stress reliever is located as respective ones of the roller wheels 28₁-28₁₀ pass by. In this embodiment, each of the stress relievers 80₁-80_{C} is configured to reduce tensile or compressive stress of the elastomeric material 32 of the track 22 at the rolling path 30₁ where that stress reliever is located as the roller wheels 28₁-28₁₀ move away from or towards an adjacent one of the cores 44₁-44_{N}. More particularly, in this embodiment, each of the stress relievers 80₁-80_{C} is configured to facilitate clastic deformation of the elastomeric material 32 of the track 22 at the rolling path 30₁ where it is located in order to effect this stress reduction. In turn, this may help to reduce or prevent cracking of the elastomeric material 32 of the track 22. Notably, in this example, as they are near the wheel guide 54 of each of the cores 44₁-44_{N}, the stress relievers 80₁-80_{C} may help to reduce or prevent cracking that may otherwise tend to occur rapidly at such locations and propagate laterally outwards.

For example, in this embodiment, considering stress relievers 80ₓ, 80_{y} that are disposed between cores 44ₓ, 44_{y} that succeed one another in the longitudinal direction of the track 22, when a given one of the roller wheels 28₁-28₁₀ rolling on the rolling path 30₁ moves away from the core 44ₓ and towards the core 44_{y}, the stress reliever 80ₓ helps to reduce tensile stress in the elastomeric material 32 of the track 22 and the stress reliever 80_{y} helps to reduce compressive stress in the elastomeric material 32 of the track 22.

Each stress reliever 80ᵢ may be implemented in any suitable way. In this embodiment, the stress reliever 80ᵢ comprises a void 82 defined by the elastomeric material 32 of the track 22. An absence of material at the void 82 may facilitate clastic deformation of the elastomeric material 32 of the track 22 that defines the void 82, thus relieving stress in the elastomeric material 32, which may help to reduce or prevent cracking of the elastomeric material 32.

In this embodiment, the void 82 of the stress reliever 80ᵢ is a recess. More particularly, in this embodiment, the recess 82 is elongated, i.e., a groove. In this example, the groove 82 is elongated transversally to the longitudinal direction of the track 22. That is, a longitudinal axis 84 of the groove 82 extends transversally to the longitudinal direction of the track 22. In this case, the grooves 82 of four of the stress relievers 80₁-80_{C} between successive ones of the cores 44₁-44_{N} can be viewed as being arranged in an X-shaped configuration. Also, in this example, as it is at least partially located in the given one of the depressions 93₁-93_{D} of the inner side 45 of the track 22, the groove 82 forms an even further lowering of the inner lower area 91 of the inner side of the track 22.

More particularly, in this embodiment, a portion 85 of the groove 82 of the stress reliever 80i is located between the wheel guide 54 of the adjacent one of the cores 44₁-44_{N} and the outer lateral edge 56₂ of the rolling path 30₁ in the widthwise direction of the track 22. Here, the portion 85 of the groove 82 is located between the guide projection 57₁ of the adjacent one of the cores 44₁-44_{N} and the outer lateral edge 56₂ of the rolling path 30₁ in the widthwise direction of the track 22. This includes a portion 86 of the groove 82 that is located in the rolling path 30₁, i.e., between the inner lateral edge 56₁ and the outer lateral edge 56₂ of the rolling path 30₁ in the widthwise direction of the track 22. Also, in this embodiment, a portion 87 of the groove 82 is aligned with the wheel guide 54 of the adjacent one of the cores 44₁-44_{N}, in this case the guide projection 57₁ of the adjacent one of the cores 44₁-44_{N}, in the widthwise direction of the track 22, and a portion 88 of the groove 82 is aligned with the adjacent one of the cores 44₁-44_{N} in the longitudinal direction of the track 22.

A depth Dᵥ of the groove 82 of the stress reliever 80ᵢ, measured normal to a bottom surface 83 of the groove 82, may be set as desired. For example, in some embodiments, the depth Dᵥ of the groove 82 may be at least 5%, in some cases at least 10%, in some cases at least 20%, in some cases at least 40%, and in some cases at least 60% of a thickness Tₜ of the track 22 between the inner surface 55 and the ground-engaging outer surface 31 of the track 22, and/or the depth Dv of the groove 82 may be no more than 60%, in some cases no more than 40%, in some cases no more than 20%, and in some cases no more than 10% of the thickness Tt of the track 22. For instance, in some embodiments, the depth Dᵥ of the groove 82 may be at least 5 mm, in some cases at least 10 mm, in some cases at least 15 mm, and in some cases at least 20 mm, and/or the depth Dᵥ of the groove 82 may be no more than 25 mm, in some cases no more than 20 mm, in some cases no more than 15 mm, and in some cases no more than 10 mm. The depth Dᵥ of the groove 82 may have any other suitable value in other embodiments.

In this embodiment, the depth Dᵥ of the groove 82 varies along the longitudinal axis 84 of the groove 82. More particularly, in this embodiment, the depth Dᵥ of the groove 82 is greater at the portion 85 of the groove 82 located between the guide projection 57₁ of the adjacent one of the cores 44₁-44_{N} and the outer lateral edge 56₂ of the rolling path 30₁ in the widthwise direction of the track 22 than at the portion 87 of the groove 82 aligned with the guide projection 57₁ of the adjacent one of the cores 44₁-44_{N} in the widthwise direction of the track 22.

A width Wᵥ of the groove 82 of the stress reliever 80ᵢ may be set as desired. For example, in some embodiments, the width Wᵥ of the groove 82 may be at least 10%, in some cases at least 20%, in some cases at least 30%, and in some cases at least 40% of a spacing S_{c} (i.e., a pitch) of the successive ones of the cores 44₁-44_{N} between which the groove 82 is located in the longitudinal direction of the track 22, and/or the width Wᵥ of the groove 82 may be no more than 40%, in some cases no more than 30%, in some case no more than 20%, and in some cases no more than 10% of the spacing S_{c} of the successive ones of the cores 44₁-44_{N}. For instance, in some embodiments, the width Wᵥ of the groove 82 may be at least 1 mm, in some cases at least 20 mm, and in some cases 50 mm, and/or the width Wᵥ of the groove 82 may be no more than 50 mm, in some cases no more than 20 mm, and in some cases no more than 1 mm. The width Wᵥ of the groove 82 may have any other suitable value in other embodiments.

In this embodiment, the width Wᵥ of the groove 82 of the stress reliever 80ᵢ varies along the longitudinal axis 84 of the groove 82. More particularly, in this embodiment, the width Wᵥ of the groove 82 is greater at the portion 85 of the groove 82 located between the guide projection 57₁ of the adjacent one of the cores 44₁-44_{N} and the outer lateral edge 56₂ of the rolling path 30₁ in the widthwise direction of the track 22 than at the portion 87 of the groove 82 aligned with the guide projection 57₁ of the adjacent one of the cores 44₁-44_{N} in the widthwise direction of the track 22.

A dimension Lᵥ of the groove 82 of the stress reliever 80ᵢ in the widthwise direction of the track 22 may be set as desired. For example, in some embodiments, the dimension Lᵥ of the groove 82 in the widthwise direction of the track 22 may be at least 5%, in some cases at least 10%, in some cases at least 20%, and in some cases at least 50% of the width Wᵣₚ of the rolling path 30₁, and/or the dimension Lᵥ of the groove 82 may be no more than 50%, in some cases no more than 20%, and in some case no more than 10% of the width Wᵣₚ of the rolling path 30₁. For instance, in some embodiments, the dimension Lᵥ of the groove 82 in the widthwise direction of the track 22 may be at least 5 mm, in some cases at least 20 mm, and in some cases 100 mm, and/or the dimension Lᵥ of the groove 82 may be no more than 100 mm, in some cases no more than 20 mm, and in some cases no more than 1 mm. The dimension Lᵥ of the groove 82 in the widthwise direction of the track 22 may have any other suitable value in other embodiments.

The groove 82 of the stress reliever 80ᵢ may be formed by the elastomeric material 32 of the track 22 during manufacturing of the track 22 in any suitable manner. In this embodiment, the groove 82 may be molded during molding of the elastomeric material 32 of the track 22 (i.e., a molded groove). In other embodiments, the groove 82 may be formed after molding of the elastomeric material 32 of the track 22 by removing elastomeric material that was molded, such as by cutting, carving, etc.

The resistance to cracking of the elastomeric material 32 of the track 22 where the cracking inhibitor 50₁ is located may thus be greater than if the cracking inhibitor 50₁ was omitted but the track 22 was otherwise identical (i.e., the cracking inhibitor 50₁ was replaced with elastomeric material identical to that contiguous to it). For example, in some embodiments, a crack growth rate where the cracking inhibitor 50₁ is located may be less than if the cracking inhibitor 501 was omitted but the track 22 was otherwise identical. For instance, in some embodiments, the crack growth rate where the cracking inhibitor 50₁ is located may at least 10% lower, in some cases at least 20% lower, and in some cases at least 50% lower than if the cracking inhibitor 50₁ was omitted but the track 22 was otherwise identical. As another example, in some embodiments, a crack initiation time where the cracking inhibitor 50₁ is located may be longer than if the cracking inhibitor 50₁ was omitted but the track 22 was otherwise identical. For instance, in some embodiments, the crack initiation time where the cracking inhibitor 50₁ is located, expressed as a number of cycles before a crack is initiated where the cracking inhibitor 50₁ is located, may at least 50% longer, in some cases at least 100% longer, in some cases at least 200% longer, and in some cases at least 500% longer than if the cracking inhibitor 50₁ was omitted but the track 22 was otherwise identical.

The cracking inhibitor 50₁ may be implemented in various other ways in other embodiments.

For instance, in some embodiments, each stress reliever 80ᵢ may be implemented in various other manners. For example, in some embodiments, the recess 82 of the stress reliever 80ᵢ may have any other shape in other embodiments (e.g., the groove 82 may be curved, partly curved and partly straight, etc., along its longitudinal axis 84; the recess 82 may not be elongated; etc.). As another example, in some embodiments, the void 82 of the stress reliever 80ᵢ may be a hole extending through the track 22 from the inner side 45 to the ground-engaging outer side 47 of the track 22.

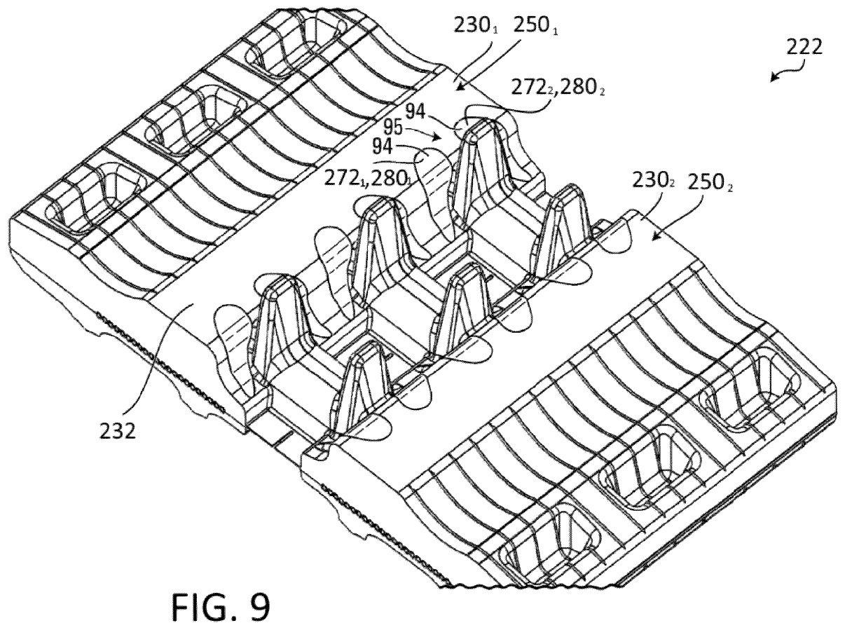

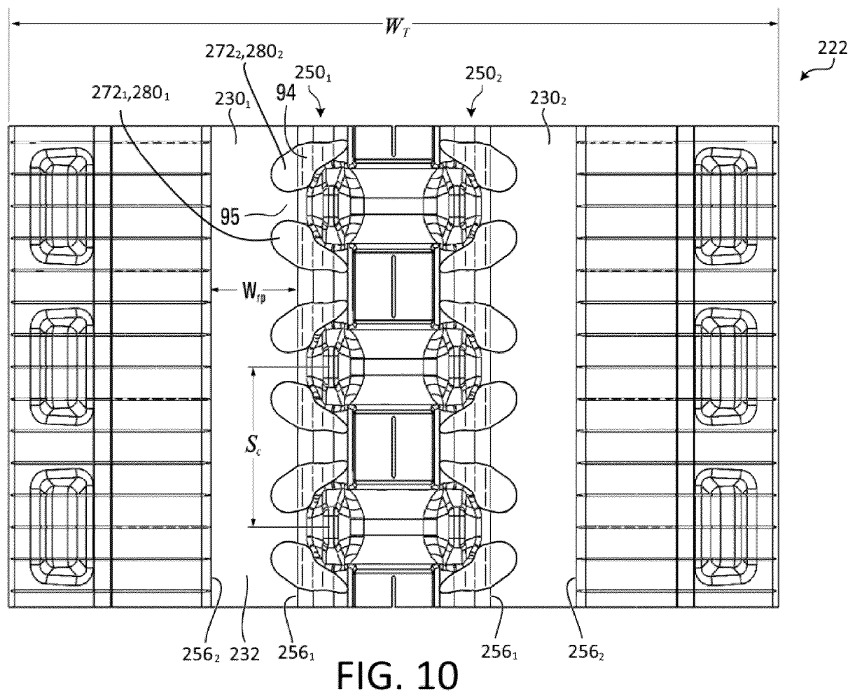

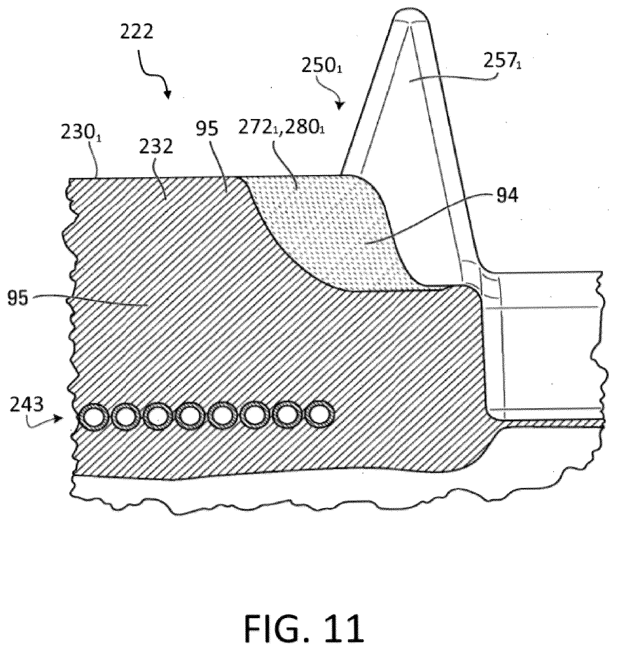

In some embodiments, as shown in FIGS. 9 to 11, the stress reliever 80ᵢ, may comprise deformable material 94 that is more easily deformable, such as more elastic and/or softer, than a portion 95 of the elastomeric material 32 of the track 22 contiguous to the deformable material 94. This may facilitate elastic deformation where the stress reliever 80ᵢ is located, which may help to reduce or prevent cracking.

The deformable material 94 may be implemented in any suitable way. In this embodiment, the deformable material 94 is elastomeric material. For instance, in some embodiments, the deformable material 94 may be a foam rubber or another soft rubber, a polyurethane foam, etc.

For example, in some embodiments, a modulus of elasticity (i.e., Young's modulus) of the deformable material 94 may be lower than a modulus of elasticity of the portion 95 of the elastomeric material 32 of the track 22. For instance, in some embodiments, the modulus of elasticity of the deformable material 94 may be no more than 90%, in some cases no more than 80%, and in some cases no more than 50% of the modulus of elasticity of the portion 95 of the elastomeric material 32 of the track 22. Alternatively or additionally, in some embodiments, a hardness of the deformable material 94 may be lower than a hardness of the portion 95 of the elastomeric material 32 of the track 22. For instance, in some embodiments, when on a same hardness scale (e.g., Shore durometers), the hardness of the deformable material 94 may be no more than 90%, in some cases no more than 80%, and in some cases no more than 50% of the hardness of the portion 95 of the elastomeric material 32 of the track 22.

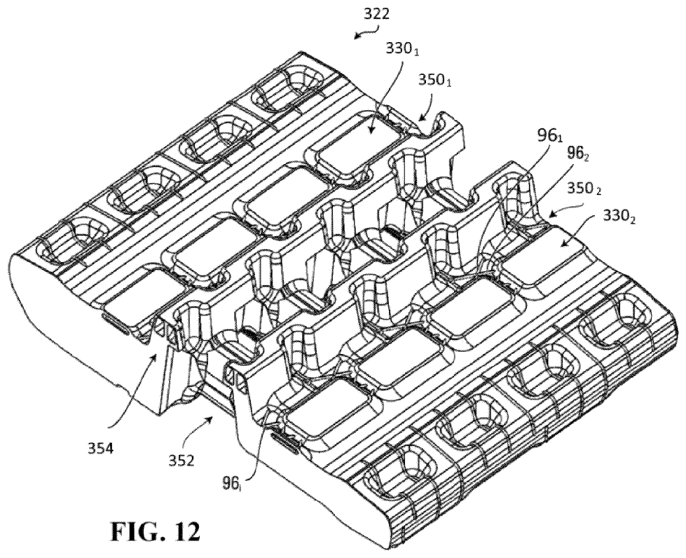

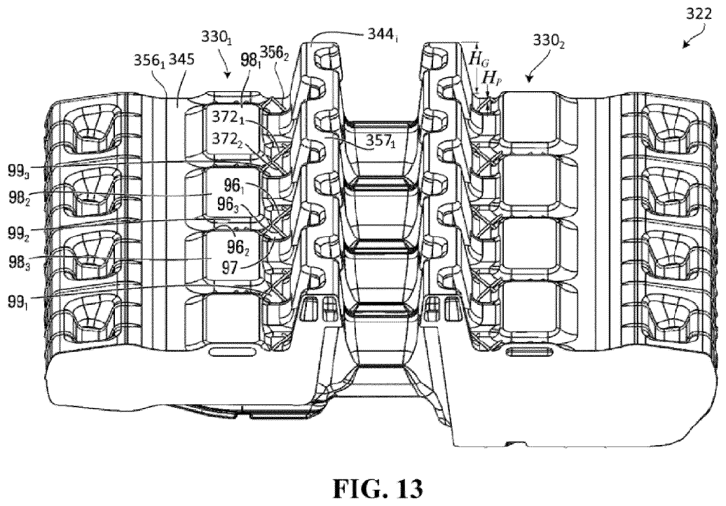

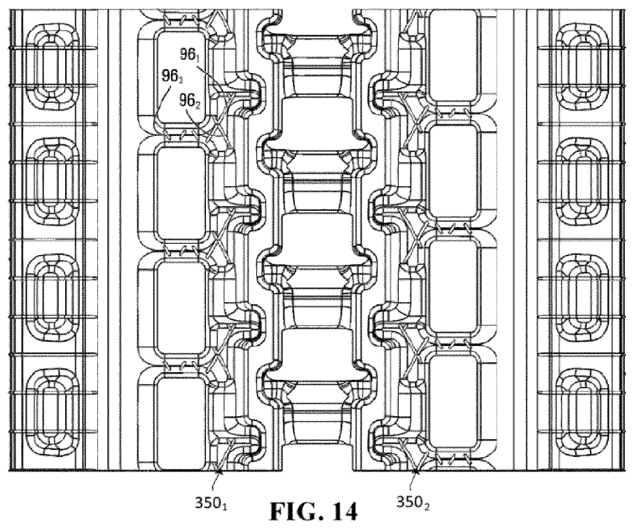

In some embodiments, as shown in FIGS. 12 to 14, the crack-inhibiting elements 72₁ -72_{C} disposed along the rolling path 30₁ between successive ones of the cores 44₁-44_{N} that succeed one another in the longitudinal direction of the track 22 may comprise elastomeric projections 96₁-96_{C} on the inner side 45 of the track 22. Additional elastomeric material of the elastomeric projections 96₁-96_{C} may impede crack propagation in the elastomeric material 32.

In this embodiment, the elastomeric projections 96₁-96_{C} are elongated and can be referred to as “ribs”. More particularly, in this embodiment, the elastomeric ribs 96₁-96_{C} are elongated transversally to the longitudinal direction of the track 22. Also, in this embodiment, certain ones of the elastomeric ribs 96₁-96_{C} intersect one another. In this case, this creates a network or web-like arrangement of the elastomeric ribs 96₁-96_{C} that may further impede propagation of cracks in the elastomeric material 32. Furthermore, in this embodiment, certain ones of the elastomeric ribs 96₁-96_{C} are disposed between flat areas 98₁-98_{F} of the rolling path 30₁ that are spaced along the longitudinal direction of the track 22 by lower areas 99₁-99_{L} so that these elastomeric ribs are disposed in the lower areas 99₁-99_{L}.

Each elastomeric rib 96ᵢ may have any suitable shape. In this embodiment, the elastomeric rib 96ᵢ is substantially straight. In other embodiments, the elastomeric rib 96ᵢ may be curved, may include straight and curved parts, etc.

The elastomeric rib 96ᵢ is shorter than the guide projection 57₁ of the adjacent one of the cores 44₁-44_{N}. That is, a height Hₚ of the elastomeric rib 96ᵢ , measured normal to a base 97 of the elastomeric rib 96ᵢ, is less than a height H_{g} of the guide projection 57₁ of the adjacent one of the cores 44₁-44_{N}. For example, in some embodiments, the height Hₚ of the elastomeric rib 96ᵢ may be no more than 15%, in some cases no more than 10%, in some cases no more than 5%, and in some case no more than 2% of the height H_{g} of the guide projection 57₁ of the adjacent one of the cores 44₁-44_{N}. As another example, in some embodiments, the height Hₚ of the elastomeric rib 96ᵢ may be no more than 10%, in some cases no more than 5%, and in some cases at least 2% of the thickness TT of the track 22. For instance, in some embodiments, the height Hₚ of the elastomeric rib 96ᵢ may be no more than 3 mm, in some cases no more than 2 mm, in some cases no more than 1 mm, in some cases no more than 0.5 mm, and in some cases no more than 0.2 mm. The height Hₚ of the elastomeric rib 96ᵢ may have any other suitable value in other embodiments.

In some embodiments, the elastomeric projections 96₁-96_{C} may define a texture of elastomeric material that impedes crack propagation in the elastomeric material 32. That is, the elastomeric projections 96₁-96_{C} may be small and spaced by elastomeric recesses of the texture of elastomeric material.

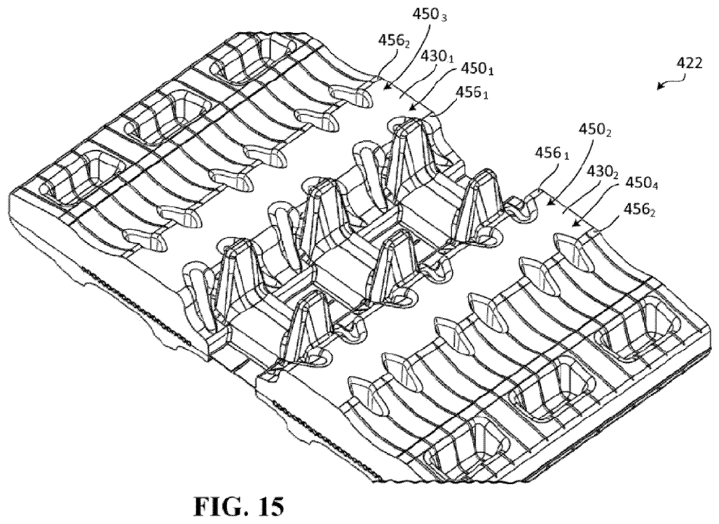

While in embodiments considered above the cracking inhibitors 50₁, 50₂ are disposed along the rolling paths 30₁, 30₂ adjacent to the inner lateral edge 56₁ of each of the rolling paths 30₁, 30₂, in other embodiments, the cracking inhibitors 50₁, 50₂ may be disposed along the rolling paths 30₁, 30₂ adjacent to the outer lateral edge 56₂ of each of the rolling paths 30₁, 30₂. Also, in other embodiments, as shown in FIG. 15, in addition to the cracking inhibitors 50₁, 50₂ disposed along the rolling paths 30₁, 30₂ adjacent to the inner lateral edge 56₁ of each of the rolling paths 30₁, 30₂, the track 22 may comprise cracking inhibitors 50₃, 50₄ similar to the cracking inhibitors 50₁, 50₂ but disposed along the rolling paths 30₁, 30₂ adjacent to the outer lateral edge 56₂ of each of the rolling paths 30₁, 30₂.

### 2. Delamination Inhibition

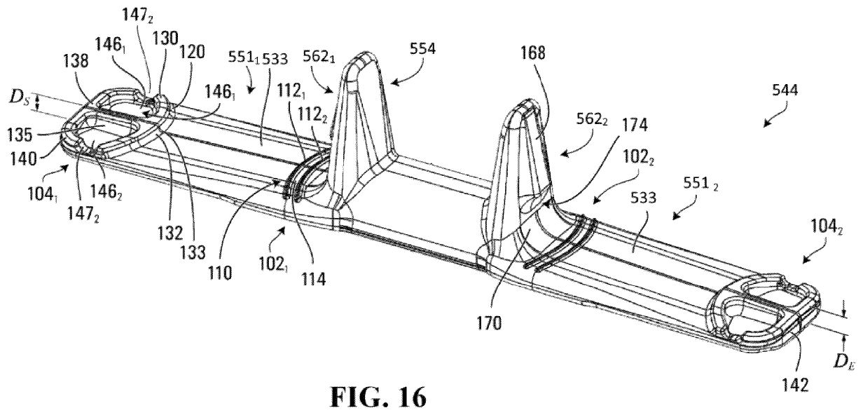

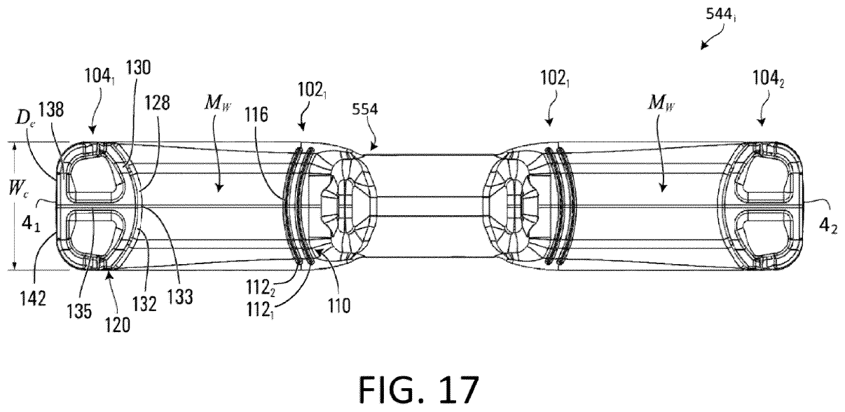

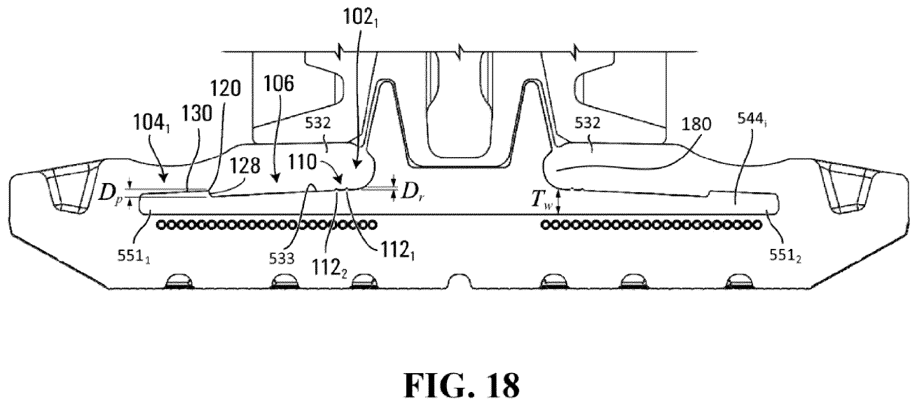

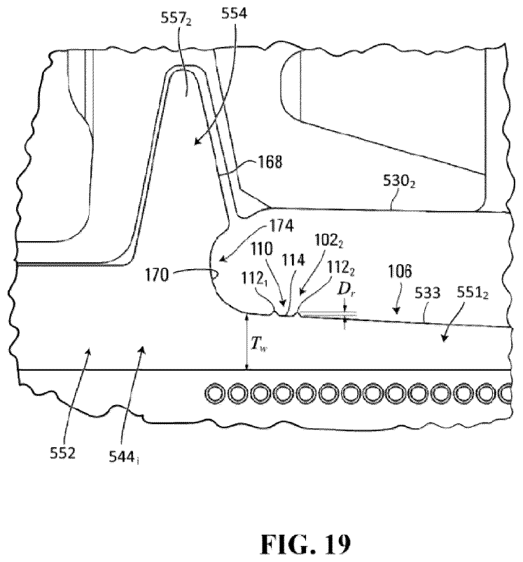

In some embodiments, as shown in FIGS. 16 to 19, each core 44ᵢ may comprise delamination inhibitors 102₁, 102₂, 104₁, 104₂ configured to inhibit delamination of the elastomeric material 32 of the track 22 from the wings 51₁, 51₂ of the core 44ᵢ. Each of the delamination inhibitors 102₁, 102₂, 104₁, 104₂ is a structure of a given one of the wings 51₁, 51₂ of the core 44ᵢ that is designed to at least reduce (i.e., reduce or prevent) delamination of the elastomeric material 32 of the track 22 from the given one of the wings 51₁, 51₂ of the core 44ᵢ, i.e., help maintain adhesion of the elastomeric material 32 of the track 22 to the given one of the wings 51₁, 51₂ of the core 44ᵢ.

The delamination inhibitors 102₁, 104₁ of the wing 51₁ of the core 44ᵢ will be further discussed below, with an understanding that a similar discussion applies to the delamination inhibitors 102₂, 104₂ of the wing 51₂ of the core 44ᵢ.

As further discussed below, in this embodiment, the delamination inhibitor 102₁ of the wing 51₁ of the core 44ᵢ is configured to impede passage of grit between the inner surface 33 of the wing 51₁ and a portion 106 of the elastomeric material 32 of the track 22 contiguous to the inner surface 33 of the wing 51₁. In that sense, the delamination inhibitor 102₁ may be referred to a “grit blocker”. Grit, which can include sand, rocks (e.g., gravel), and/or other small granular abrasive objects or other dirt and may be contained in water and/or other liquid (e.g., oil) that forms grit-containing media, from an environment of the vehicle 10 may tend to enter inside the track 22 between its elastomeric material 32 and the core 44ᵢ via cracks, holes and/or other wear effects under action of the roller wheels 28₁-28₁₀. Also, in this embodiment, the delamination inhibitor 104₁ of the wing 51₁ of the core 44ᵢ is configured to oppose shearing of the portion 106 of the elastomeric material 32 of the track 22 relative to the inner surface 33 of the wing 51₁ under loading from respective ones of the roller wheels 28₁-28₁₀. In that sense, the delamination inhibitor 104₁ may be referred to as a “shear limiter”. The grit blocker 102₁ and the shear limiter 104₁ may thus help to reduce or prevent delamination of the portion 106 of the elastomeric material 32 of the track 22 from the inner surface 33 of the wing 51₁ by helping to maintain adhesion therebetween.

In this embodiment, at least part of the grit blocker 102₁ of the wing 51₁ of the core 44ᵢis located adjacent to the wheel guide 54 of the core 44ᵢ, i.e., closer to the wheel guide 54 than to the longitudinal end 48₁ of the core 44ᵢ in the longitudinal direction of the core 44ᵢ. More particularly, in this embodiment, at least part of the grit blocker 102₁ is located adjacent to the guide projection 57 of the core 44ᵢ. In this example, the grit blocker 102₁ is entirely located between the guide projection 57₁ of the core 44ᵢ and a midpoint M_{w} of the wing 51₁ of the core 44ᵢ in the longitudinal direction of the core 44ᵢ.

The grit blocker 102₁ of the wing 51₁ of the core 44ᵢ may be implemented in any suitable way. In this embodiment, the grit blocker 102₁ comprises an unevenness 110 of the inner surface 33 of the wing 51₁ in the longitudinal direction of the core 44ᵢ such that the inner surface 33 of the wing 51₁ is uneven (i.e., non-flat) in longitudinal direction of the core 44ᵢ about the grit blocker 102₁. The unevenness 110 of the inner surface 33 of the wing 51₁ comprises one or more grit-blocking recesses and/or one or more grit-blocking projections creating an impediment to passage of grit between the unevenness 110 and the portion 106 of the elastomeric material 32 of the track 22 contiguous to the inner surface 33 of the wing 51₁.

In this embodiment, the unevenness 110 of the inner surface 33 of the wing 51₁ of the core 44ᵢ comprises grit-blocking projections 112₁-112_{R} that are spaced apart in the longitudinal direction of the core 44ᵢ. In this example, a recess 114 can be viewed as being located between adjacent ones of the grit-blocking projections 112₁-112_{R}.

Each grit-blocking projection 112ₓ of the unevenness 110 of the inner surface 33 of the wing 51₁ of the core 44ᵢ may have any suitable shape. In this embodiment, the grit-blocking projection 112ₓ is elongated, and can be referred to as a “ridge”. More particularly, in this embodiment, the grit-blocking ridge 112ₓ is elongated transversally to the longitudinal direction of the core 44ᵢ. Also, in this embodiment, the grit-blocking ridge 112ₓ is curved. In this example, the grit-blocking ridge 112ₓ is curved such that an apex 116 of the grit-blocking ridge 112ₓ extends farther from the wheel guide 54 of the core 44ᵢ in the longitudinal direction of the core 44ᵢ. This may provide stress relief when a given one of the roller wheels 28₁-28₁₀ passes over the core 44ᵢ. In other embodiments, the grit-blocking ridge 112ₓ may be straight, comprise curved and straight parts, etc.

In this embodiment, the grit-blocking ridge 112ₓ extends over at least a majority (i.e., a majority or an entirety) of a width W_{c} of the wing 51₁ where the ridge 112ₓ is located. For example, in some embodiments, the grit-blocking ridge 112ₓ may extend over at least 60%, in some cases at least 75%, and in some cases at least 90% of the width W_{c} of the wing 51₁ where the ridge 112ₓ is located.

A dimension Dᵣ of the grit-blocking ridge 112ₓ in the thicknesswise direction of the core 44ᵢ, which in this case is a height, may be set as desired. For example, in some embodiments, the height Dᵣ of the grit-blocking ridge 112ₓ may be at least 1%, in some cases at least 5%, in some cases at least 10%, and in some cases at least 20% of a thickness T_{w} of the wing 511 where the ridge 112ₓ is located, and/or may be the height Dᵣ of the grit-blocking ridge 112ₓ may be no more than 20%, in some cases no more than 10%, in some cases no more than 5%, and in some cases no more than 1% of the thickness T_{w} of the wing 51₁. For instance, in some embodiments, the height Dᵣ of the grit-blocking ridge 112ₓ may be at least 0.2 mm, in some cases at least 1 mm, in some cases at least 2 mm, in some cases at least 5 mm, and in some cases at least 8 mm, and/or the height Dᵣ of the grit-blocking ridge 112ₓ may be no more than 8 mm, in some cases no more than 5 mm, in some cases no more than 2 mm, and in some cases no more than 1 mm. The height Dᵣ of the grit-blocking ridge 112ₓ may have any other suitable value in other embodiments.

In this embodiment, at least part of the shear limiter 104₁ of the wing 51₁ of the core 44ᵢ is located adjacent to the longitudinal end 48₁ of the core 44ᵢ, i.e., closer to the longitudinal end 48₁ of the core 44ᵢ than to the wheel guide 54 of the core 44ᵢ in the longitudinal direction of the core 44ᵢ. In this example, the shear limiter 104₁ is entirely located between the longitudinal end 48₁ of the core 44ᵢ and the midpoint M_{w} of the wing 51₁ of the core 44ᵢ in the longitudinal direction of the core 44ᵢ.

The shear limiter 104₁ of the wing 51₁ of the core 44ᵢ may be implemented in any suitable way. In this embodiment, the shear limiter 104₁ comprises an unevenness 120 of the inner surface 33 of the wing 51₁ in the longitudinal direction of the core 44ᵢ such that the inner surface 33 of the wing 51₁ is uneven (i.e., non-flat) in longitudinal direction of the core 44ᵢ about the shear limiter 104₁. The unevenness 120 of the inner surface 33 of the wing 51₁ comprises one or more projections and/or one or more recesses creating an abutment 128 that abuts against the portion 106 of the elastomeric material 32 of the track 22 to limit shearing of the portion 106 of the elastomeric material 32 of the track 22 relative to the inner surface 33 of the wing 51₁.

In this embodiment, the unevenness 120 of the inner surface of the wing 51₁ of the core 44ᵢ comprises a shear-limiting projection 130 that defines the abutment 128. The shear-limiting projection 130 comprises an inward surface 132 that faces towards the wheel guide 54 of the core 44ᵢ and abuts against the portion 106 of the elastomeric material 32 of the track 22. Under loading of respective ones of the roller wheels 28₁-28₁₀, the shear-limiting projection 130 opposes a tendency of the portion 106 of the elastomeric material 32 of the track 22 to shear laterally outwardly relative to the inner surface 33 of the wing 51₁.

The shear-limiting projection 130 of the shear limiter 104₁ may have any suitable shape. In this embodiment, the shear-limiting projection 130 is elongated, and can thus be referred to as a “rib”. More particularly, in this embodiment, the shear-limiting rib 130 is elongated transversally to the longitudinal direction of the core 44ᵢ.

In this embodiment, the inward surface 132 of the shear-limiting rib 130 is uneven (i.e., non-flat) in the widthwise direction of the core 44ᵢ. This may help to progressively compress the portion 106 of the elastomeric material 32 of the track 22 against the inward surface 132 of the shear-limiting rib 130 as a given one of the roller wheels 28₁-28₁₀ approaches, passes over, moves away from the core 44ᵢ. For instance, this may help to reduce displacement of the portion 106 of the elastomeric material 32 of the track 22 and/or provide stress relief at a bonding interface between the core 44ᵢ and the portion 106 of the elastomeric material 32 of the track 22. In this example, the inward surface 132 of the shear-limiting rib 130 is uneven such that an apex 133 of the surface 132 extends farther from the longitudinal end 48₁ of the core 44ᵢ in the longitudinal direction of the core 44ᵢ. More particularly, in this embodiment, the inward surface 132 of the shear-limiting rib 130 is curved. In other embodiments, the inward surface 132 of the shear-limiting rib 130 may be straight, comprise curved and straight parts, etc.

In this example, the shear-limiting rib 130 extends over at least the majority of the width W_{c} of the wing 511 where the shear-limiting rib 130 is located. For instance, in some embodiments, the shear-limiting rib 130 may extend over at least 60%, in some cases at least 75%, and in some cases at least 90% of the width W_{c} of the wing 511 where the shear-limiting rib 130 is located.

A dimension Dₚ of the shear-limiting rib 130 in the thicknesswise direction of the core 44ᵢ, which in this case is a height, may be set as desired. For example, in some embodiments, the height Dₚ of the shear-limiting rib 130 may be at least 5%, in some cases at least 10%, in some cases at least 20%, and in some cases at least 50% of the thickness T_{w} of the wing 51₁ where the shear-limiting rib 130 is located, and/or the height Dₚ of the shear-limiting rib 130 may be no more than 50%, in some cases no more than 20%, in some cases no more than 10%, and in some cases no more than 10% of the thickness T_{w} of the wing 51₁. For instance, in some embodiments, the height Dₚ of the shear-limiting rib 130 may be at least 0.2 mm, in some cases at least 1 mm, in some cases at least 5 mm, in some cases at least 10 mm, and in some cases at least 15 mm, and/or the height Dₚ of the shear-limiting rib 130 may be no more than 15 mm, in some cases no more than 10 mm, in some cases no more than 5 mm, and in some cases no more than 1 mm. The height Dₚ of the shear-limiting rib 130 may have any other suitable value in other embodiments.

In this embodiment, the shear-limiter 104₁ also comprises a stiffening projection 135 extending transversally to the shear-limiting rib 130 to stiffen the longitudinal end of the core 44ᵢ (e.g., against bending under loading of the roller wheels). More particularly, in this embodiment, the stiffening projection 135 is elongated, and can thus be referred to as a “rib”. In this example, the stiffening rib 135 is elongated in to the longitudinal direction of the core 44ᵢ. Thus, in this example, the shear-limiting rib 130 and the stiffening rib 135 are arranged in a generally T-shaped or anchor-shaped configuration.

In this example, the stiffening rib 135 extends over less than the majority of the width W_{c} of the wing 511 where the stiffening rib 135 is located. For instance, in some embodiments, the stiffening rib 135 may extend over no more than 40%, in some cases no more than 30%, and in some cases no more than 20% of the width W_{c} of the wing 51₁ where the stiffening rib 135 is located.

A dimension Dₛ of the stiffening rib 135 in the thicknesswise direction of the core 44ᵢ, which in this case is a height, may be set as desired. For example, in some embodiments, the height Dₛ of the stiffening rib 135 may be at least 5%, in some cases at least 10%, in some cases at least 20%, and in some cases at least 50% of the thickness T_{w} of the wing 51₁ where the stiffening rib 135 is located, and/or the height Dₛ of the stiffening rib 135 may be no more than 50%, in some cases no more than 20%, in some cases no more than 10% of the thickness T_{w} of the wing 511. For instance, in some embodiments, the height Dₛ of the stiffening rib 135 may be at least 5 mm, in some cases at least 10 mm, and in some cases at least 15 mm, and/or the height Dₛ of the stiffening rib 135 may be no more than 15 mm, in some cases no more than 10 mm, and in some cases no more than 5 mm. The height Dₛ of the stiffening rib 135 may have any other suitable value in other embodiments.

Also, in this embodiment, the shear-limiter 104₁ also comprises an end projection 138 that is closest to the longitudinal end 48₁ of the core 44ᵢ, i.e., closer to the longitudinal end 48₁ of the core 44ᵢ than the shear-limiting rib 130 and the stiffening rib 135, to form an enlargement 140 of the core 44ᵢ that may help to protect the track 22 against “edge-cutting” when, as the vehicle 10 moves on the ground, the lateral edge 31₁ of the track 22 impacts (i.e., makes contact with) an obstacle on the ground (e.g., a curb, a sidewalk, a rock, an abrupt change in ground level, etc.). For example, in some cases, without the enlargement 140, the longitudinal end 48₁ of the core 44ᵢ may be too sharp and induce stresses in the elastomeric material 32 of the track 22 between the longitudinal end 48₁ of the core 44ᵢ and the lateral edge 31₁ of the track 22 that may lead to tearing of that elastomeric material.

In this example, the end projection 138 of the core 44ᵢ does not extend to the longitudinal end 48₁ of the core 44ᵢ but rather stops before the longitudinal end 481 of the core 44ᵢ. This results in a step 142 between the end projection 138 and the longitudinal end 48ᵢ of the core 44ᵢ, which may provide a gradual transition to the longitudinal end 48₁ of the core 44ᵢ.

In this embodiment, the end projection 138 of the core 44ᵢ extends transversally to the stiffening rib 135. More particularly, in this embodiment, the end projection 138 is elongated, and can thus be referred to as a “rib”. In this example, the end rib 138 is elongated transversally to the longitudinal direction of the core 44ᵢ.

In this example, the end rib 138 extends over at least the majority of the width W_{c} of the wing 51₁ where the end rib 138 is located. For instance, in some embodiments, the end rib 138 may extend over at least 60%, in some cases at least 75%, and in some cases at least 90% of the width W_{c} of the wing 51₁ where the end rib 138 is located.

A dimension Dₑ of the end rib 138 in the thicknesswise direction of the core 44ᵢ, which in this case is a height, may be set as desired. For example, in some embodiments, the height Dₑ of the end rib 138 may be at least 5%, in some cases at least 10%, in some cases at least 20%, in some cases at least 50%, and in some cases 100% of the thickness T_{w} of the wing 51₁ where the end rib 138 is located, and/or the height Dₑ of the end rib 138 may be no more than 80%, in some cases no more than 50%, in some cases no more than 20%, and in some cases no more than 10% of the thickness T_{w} of the wing 51₁. The height Dₑ of the end rib 138 may have any other suitable value in other embodiments.

In this embodiment, the shear-limiter 104₁ comprises a pair of hollow spaces 146₁, 146₂ delimited by the shear-limiting rib 130, the stiffening rib 135, and the end rib 138. In this example, gaps 147₁, 147₂ between respective ends of the shear-limiting rib 130 and the end rib 138 result in the hollow spaces 146₁, 146₂ being open at front and back sides of the core 44ᵢ. This may help for weight reduction and/or mechanically interlocking the elastomeric material 32 to the core 44ᵢ.

In addition to the grit blockers 102₁, 102₂ and the shear limiters 104₁, 104₂ of the wings 51₁, 51₂ of the core 44ᵢ, in this embodiment, the wheel-facing side 62₁ of each of the guide projections 57₁, 57₂ of the core 44ᵢ comprises an upper surface 168 and a lower surface 170 that recedes inwardly from the upper surface 168 to form a recess 174 configured to impede passage of grit between the recess 174 and an adjoining portion 180 of the elastomeric material 32 of the track 22 in the recess 174, such as, for example, as discussed in U.S. Pat. No. 8,590,986, which is incorporated by reference herein. This may further help to retain proper adhesion between the core 44ᵢ and the elastomeric material 32 of the track 22.

While in the embodiment considered above the vehicle 10 is a compact track loader, in other embodiments, the vehicle 10 may be any other type of construction vehicle (e.g., a paver, a bulldozer, a backhoe loader, an excavator, a telehandler, etc.) for performing construction work, an agricultural vehicle (e.g., a rice harvester or other harvester) for performing agricultural work, or any other suitable type of vehicle (e.g., a forestry vehicle, etc.). Although operable off paved roads, the vehicle 10 may also be operable on paved roads in some cases. Also, while in the embodiment considered above the vehicle 10 is driven by a human operator in the vehicle 10, in other embodiments, the vehicle 10 may be an unmanned ground vehicle (e.g., a teleoperated or autonomous unmanned ground vehicle).

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

Any feature of any embodiment discussed herein may be combined with any feature of any other embodiment discussed herein in some examples of implementation.

In case of any discrepancy, inconsistency, or other difference between terms used herein and terms used in any document incorporated by reference herein, meanings of the terms used herein are to prevail and be used.

Although various embodiments and examples have been presented, this was for purposes of description, but should not be limiting. Various modifications and enhancements will become apparent to those of ordinary skill in the art.

1. A track for traction of a vehicle, the track being mountable around a plurality of wheels that includes a plurality of roller wheels for rolling on a bottom run of the track along a rolling path of the track, the track comprising:
a ground-engaging outer side;
an inner side opposite to the ground-engaging outer side;
elastomeric material allowing the track to flex around the wheels; and
a plurality of cores at least partially embedded in the elastomeric material, distributed in a longitudinal direction of the track, and extending transversally to the longitudinal direction of the track, each of the plurality of cores comprising:
a pair of wings extending in a longitudinal direction of the core, each wing of the pair comprising a delamination inhibitor configured to inhibit delamination of the elastomeric material from the wing; and
a wheel engager disposed between the wings to engage the roller wheels.

2. The track of claim 1, wherein the delamination inhibitor is configured to impede passage of grit between surface of the wing and a portion of the elastomeric material contiguous to the surface of the wing.

3. The track of claim 1, wherein: the core comprises a wheel guide configured to contact the roller wheels to guide the track; and at least part of the delamination inhibitor is located closer to the wheel guide than to a longitudinal end of the core in a longitudinal direction of the core.

4. The track of claim 1, wherein the delamination inhibitor comprises an unevenness of a surface of the wing.

5. The track of claim 4, wherein the unevenness of the surface of the wing comprises one or a combination of projections and recesses that are spaced apart in the longitudinal direction of the core.

6. The track of claim 5, wherein each of the projections and recesses extends over at least a majority of a width of the wing.

7. The track of claim 1, wherein the delamination inhibitor is configured to oppose shearing of a portion of the elastomeric material contiguous to surface of the wing relative to the surface of the wing under loading from respective ones of the roller wheels.

8. The track of claim 4, wherein the surface of the wing is an inner surface of the wing oriented towards the ground-engaging outer side of the track.

9. The track of claim 7, wherein when there is a combination of the projections and recesses, each of the recesses is located between two of the projections.

10. The track of claim 6, wherein each of the projections and recesses is entirely located between a longitudinal end of the wing and a midpoint of the wing.

11. The track of claim 6, wherein the projections and recesses are straight, curved or a combination thereof.

12. The track of claim 4, wherein the unevenness has a height or depth of at least 1% of a thickness of the wing where the unevenness is located.

13. The track of claim 4, wherein the unevenness has a height or depth of no more than 20% of a thickness of the wing where the unevenness is located.

14. The track of claim 2, wherein the delamination inhibitor comprises grit-blocking projections and grit-blocking recesses that are spaced apart in the longitudinal direction of the core.

15. The track of claim 2, wherein the grit is one or more of: sand, rocks, dirt, other granular abrasive objects, and grit-containing liquid media.

16. The track of claim 7, wherein the delamination inhibitor comprises a shear limiter on the surface of the wing located at or close to a longitudinal end of the core.

17. The track of claim 16, wherein the shear limiter comprises one or a combination of projections and recesses configured to abut against the portion of the elastomeric material.

18. The track of claim 17, wherein when the shear limiter comprises projections, at least one of the projections is a shear-limiting projection having a projection surface facing towards the wheel engager and configured to abut against the portion of the elastomeric material when the wheel engager is engaged with the roller wheels.

19. The track of claim 17, wherein when the shear limiter comprises projections, at least one of the projections is a stiffening projection extending longitudinally to the core and configured to stiffen the longitudinal end of the core.

20. The track of claim 17, wherein when the shear limiter comprises projections, at least one of the projections is an end projection located at or close to the longitudinal end of the core and configured to protect the track against edge-cutting.
